(19) United States
(12) Patent Application Publication
(10) Pub. No.: US 2005/0207101 A1
(43) Pub. Date: Sep. 22, 2005

(54) Display device having an adjustable display screen

(75) Inventors: I-Pin Hwang, Tainan City (TW); Hsing-Yeu Chang, Hsin Tien City (TW); Lin-Ming Chen, Kuei Shan Hsiang (TW); Chun-Leung Choi, Tainan City (TW); Po-Chih Yang, Kaohsiung City (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: CHI LIN TECHNOLOGY CO., LTD.

(21) Appl. No.: 11/078,029

(22) Filed: Mar. 11, 2005

(30) Foreign Application Priority Data
Mar. 17, 2004 (TW) 093107121

(51) Int. Cl. G06F 1/16

(52) U.S. Cl. 361/681; 361/600

(57) ABSTRACT

A display device includes a base, a display unit having a display screen, a support mounted on the base to support the display unit, and a slide mechanism provided on a back panel of the display screen. The support is connected to the slide mechanism so that the display unit is slidable and pivotable relative to the support. The support may include a link unit and an arm unit both of which are rotatable relative to the base. Further, the arm unit is connected to the slide mechanism and is rotatable and slidable relative to the display unit.

### CROSS-REFERENCE TO RELATED APPLICATION

This application claims priority from Taiwanese Invention Patent Application No. 93107121 filed on Mar. 17, 2004.

### BACKGROUND OF THE INVENTION

1. Field of the Invention

This invention relates to a display device, more particularly to a display device having a display screen which can be adjusted to a substantially horizontal position.

2. Description of the Related Art

Display devices, such as monitors, typically include a display screen mounted on an upper side of a support. In order to meet different requirements of users, the support is generally provided with an adjustment function for adjusting an inclination angle of the display screen. However, since display devices are of generally a vertical type in which screens are upstanding in their state of use, adjustability of the supports thereof is designed such that the screens are adjustable from an upright position to an inclining position by a small angle. Although such a small angle adjustment of the conventional display devices can provide different viewing angles to users, it is difficult to install the display devices in such a way as to place horizontally the display screens thereof like a touch screen which is usually disposed horizontally below the eyes of a user during use.

U.S. Pat. No. 6,766,994 B2 discloses a monitor which includes upper and lower support members mounted on a base to support a monitor panel. The lower support is connected pivotally to the base, whereas the upper support is not rotatable relative to the base. The upper support is telescopic and includes two parts which are slidable relative to each other, and a slide groove provided in the upper support for sliding movements of the two parts. While the monitor as such permits the monitor panel to change in position, it cannot be inclined forward or placed in a substantially horizontal position. In addition, the bulky construction thereof requires a substantial space for storage or installation.

### SUMMARY OF THE INVENTION

An object of the present invention is to provide a display device with a display screen which can be adjusted to a substantially horizontal position.

Another object of the present invention is to provide a display device with a support which permits a display screen to change in position for a wide range of inclination angles.

According to the present invention, a display device comprises: a display unit having a display screen and a back panel; a base; and a support mounted on the base and connected to the display unit. The support includes a link unit fixed to the base and connected pivotally to a lower portion of the display unit; and an arm unit mounted pivotally on the base and connected movably to an upper portion of the display unit. The arm unit is rotatable and slidable relative to said display unit.

The display device may further comprise a slide mechanism mounted on the display unit and connected to the arm unit. The slide mechanism includes a slide rail which is disposed on the back panel. The arm unit has an upper part sliding along the slide rail. Preferably, the slide rail extends in a top-to-bottom direction of the back panel and is substantially parallel to a plane of the display screen.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of the first preferred embodiment of a display device according to the present invention;

FIG. 2 is an exploded view of a portion of the first preferred embodiment;

FIG. 3 is an exploded view of another portion of the first preferred embodiment;

FIG. 4 is a side view of the first preferred embodiment;

FIG. 5 is a fragmentary view of the first preferred embodiment;

FIG. 6 is the same view as FIG. 4, but with a display unit being inclined rearward;

FIG. 7 is the same view as FIG. 5, but with a locking mechanism being placed in an unlocking position;

FIG. 8 is the same view as FIG. 4, but with the display unit being placed horizontally;

FIG. 9 is an exploded view of the second preferred embodiment of the present invention;

FIG. 10 is a fragmentary sectional view of the second preferred embodiment; and

FIG. 11 is the same view as FIG. 10, but with a locking mechanism being placed in a locking position.

### DETAILED DESCRIPTION OF THE PREFERRED EMBODIMENTS

Before the present invention is described in greater detail, it should be noted that same reference numerals have been used to denote like elements throughout the specification.

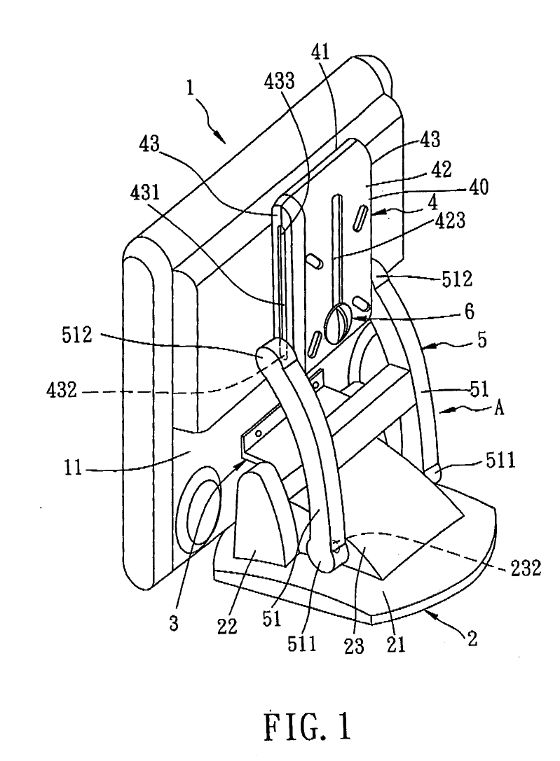

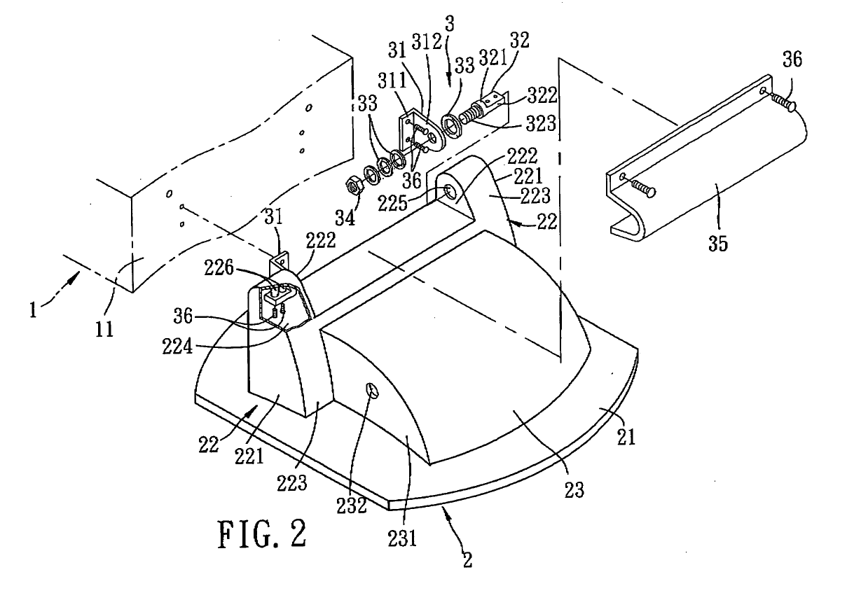

Referring to FIGS. 1 and 2, the first preferred embodiment of a display device according to the present invention includes a display unit 1 having a display screen (not shown), a base 2, and a support unit (A) mounted on the base 2 between the base 2 and the display unit 1. The display unit 1 includes a back panel 11 disposed at a rear side. The base 2 includes a base plate 21 which is hollow at a bottom portion thereof, left and right mounting seats 22 projecting upward from the base plate 21, a pivot seat 23 projecting upward from the base plate 21 rearwardly of the mounting seats 22. Each mounting seat 22 has an outer wall 221, an opposite inner wall 222, a connecting wall 223 interconnecting the outer and inner walls 221, 222, and a space 224 defined by the outer, inner and connecting walls 221, 222, 223. The inner walls 222 respectively have mounting holes 225 which are disposed at the same height. Each connecting wall 223 has two internally threaded tubes 226 which project downward. The pivot seat 23 includes left and right walls 231 each having a pivot hole 232.

The support (A) includes a link unit 3 mounted pivotally on the mounting seats 22, and an arm unit 5. A slide mechanism 4 is fixedly connected to the back panel 11 of the display unit 1, and a locking mechanism 6 is attached to the slide mechanism 4. The link unit 3 is connected to a lower portion of the display unit 1, and includes left and right links 31 attached to the back panel 11, left and right bolts 32 (only the right bolt 32 is shown) respectively extending through the links 31 to connect pivotally the links 31 to the respective mounting seats 22, a plurality of packing rings 33 disposed around each bolt 32, and a nut 34 attached to each bolt 32 to depress the packing rings 33. A cover 35 is used to cover the bolts 32 and the links 31 at the rear side of the display unit 1.

Each link 31 has a first part 311 which is face-to-face in contact with and fixed to the back panel 11, and a second part 312 to be pivoted to the inner wall 222 of the corresponding mounting seat 22. Each bolt 32 has a pivot portion 321 rotatably extending into the second part 312 of the corresponding link 31 and into the mounting hole 225 of the corresponding inner wall 222, a screw portion 323, and a flat portion 322 extending into the corresponding space 224 and beneath the internally threaded tubes 226. Each flat portion 322 is screwed to bottom ends of the corresponding threaded tubes 226 by means of screws 36. Each nut 34 is attached to the corresponding screw portion 323 to depress the packing rings 33. After assembly, the links 31 are rotatable about the respective bolts 32 so that the inclining angle of the display unit can be adjusted. The cover 35 is mounted on the rear side of the back panel 11 by means of screws 36 so as to cover the links 31 and the bolts 32.

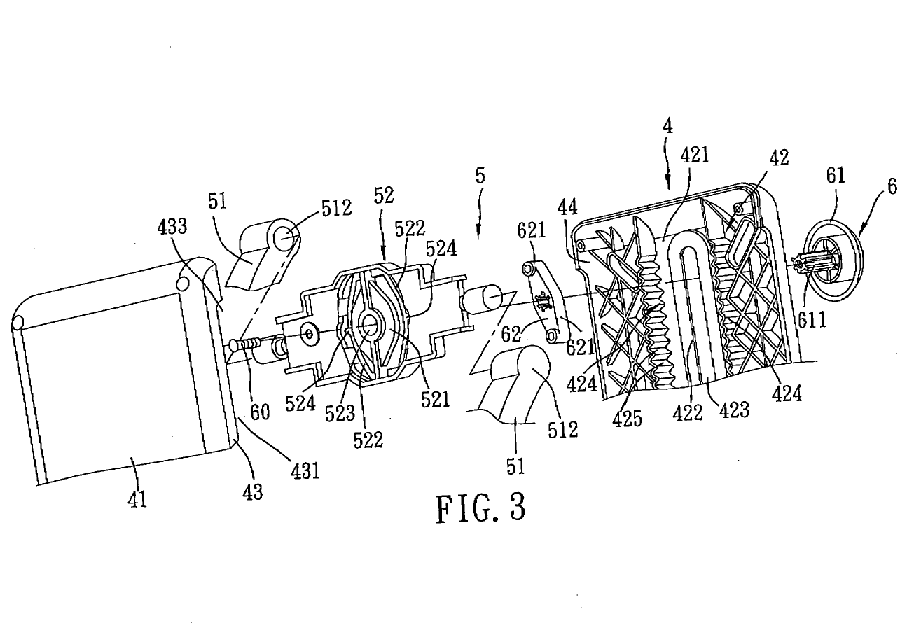

Referring to FIG. 3 in combination with FIG. 1, the slide mechanism 4 is fixed to the rear side of the back panel 11 above the link unit 3 and includes a flat case 40. The flat case 40 includes a front wall 41 fixed to the back panel 11, a rear wall 42 opposite to the front wall 41, left and right side walls 43 interconnecting the front and rear walls 41, 42, and a sliding space 44 defined by the front and rear walls 41, 42. The rear wall 42 has an inner face 421 facing the sliding space 44, an outer face 422, a through hole 423 extending through the rear wall 42, and two elongated first engaging members 424 projecting into the sliding space 44 from the inner face 421 on two sides of the through hole 423. Each first engaging member 424 has a plurality of engaging grooves 425. The side walls 43 are provided respectively with slide grooves 431 which extend in a top-to-bottom direction. Each slide groove 431 has bottom and top ends 432, 433. The slide grooves 431 and the sliding space 44 cooperatively form a slide rail that extends in a substantially top-to-bottom direction of the back panel 11 and is substantially parallel to the display screen of the display unit 1.

The arm unit 5 is connected to an upper portion of the display unit 1, and includes left and right arms 51 and a bridge member 52 interconnecting the arms 51. The arms 51 are longer than the links 31. Each arm 51 has a lower part 511, and an upper part 512. The lower part 511 is pivoted to the corresponding pivot hole 232 of the pivot seat 23. The bridge member 52 extends within the sliding space 44 between the front and rear walls 41, 42 and has two opposite ends which extend respectively into the slide grooves 431 and which are connected pivotally to the upper parts 512 of the respective arms 51. The bridge member 52 includes abridge plate 521, and left and right second engaging members 522 disposed on the bridge plate 521 proximate to the respective first engaging members 424. The bridge plate 521 has an opening 523 in alignment with the through hole 423. The second engaging members 522 are curved and each have an engaging tooth 524 projecting outwardly therefrom.

The locking mechanism 6 includes a rotary knob 61, a pusher 62 attached to the rotary knob 61, and a securing element 60. The rotary knob 61 has a stem 611 which extends through the through hole 423 of the rear wall 42 and the opening 523 of the bridge plate 521. The stem 611 is inserted into the pusher 62 and is connected to the pusher 62 through the interengagement of radial protrusions and recesses. The pusher 62 includes two opposite radial legs 621 for respectively pushing the second engaging members 522 in radial directions. The securing element 60 is threadedly attached to the stem 611 of the rotary knob 61, thereby attaching the pusher 62 to the rotary knob 61.

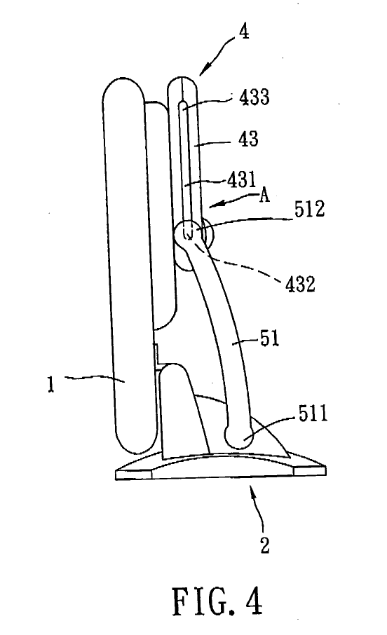

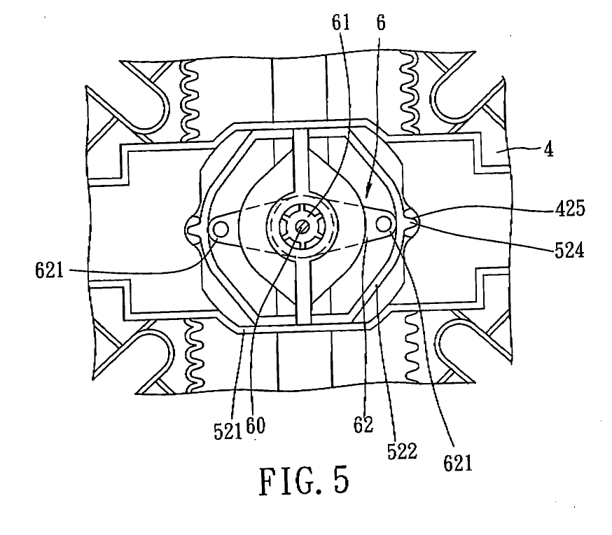

Referring to FIGS. 4 and 5, when the display unit 1 is placed in an upstanding position as shown in FIG. 4, the pusher 62 is horizontal, and the opposite legs 621 push the respective second engaging members 522 so that the engaging tooth 524 of each second engaging member 522 engages one of the engaging grooves 425 of the corresponding first engaging member 424. In this state, the locking mechanism 6 is in a locking position, and the upper parts 512 of the arms 51 are positioned at the bottom ends 432 of the respective slide grooves 431.

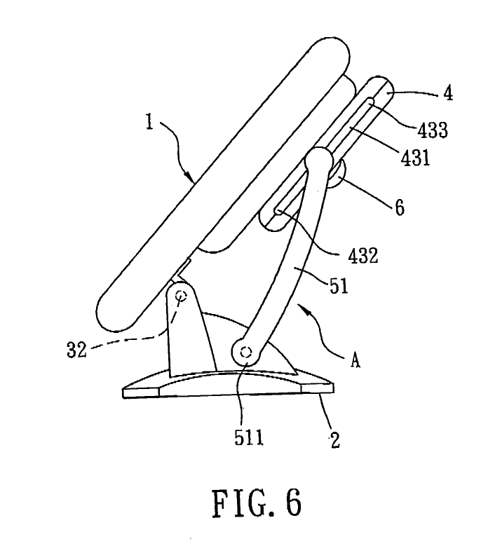

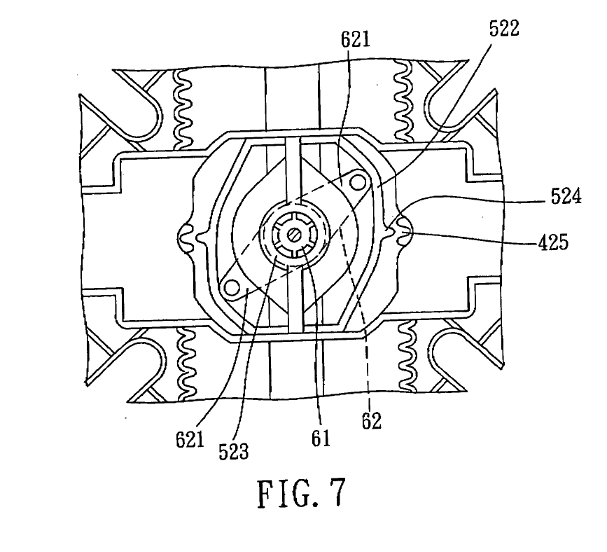

When the inclining angle of the display unit 1 is to be adjusted, the rotary knob 61 is first rotated so that the pusher 62 is turned to disengage the legs 621 from the second engaging members 522, as shown in FIGS. 6 and 7, thereby moving each engaging tooth 524 away from the corresponding engaging groove 425. In this state, the locking mechanism 6 is an unlocking position, and the display unit 1 is turned to incline rearward. When a desired inclining angle is reached, the rotary knob 61 may be rotated in a reverse direction so that the legs 621 push once again the respective second engaging members 522 to engage the engaging teeth 524 with the respective engaging grooves 425.

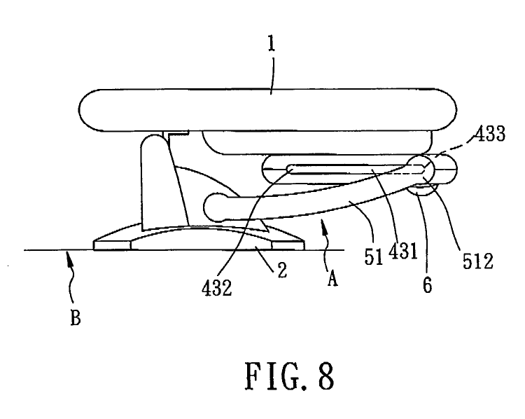

Referring to FIG. 8, when the upper parts 512 of the arms 51 are slid to the top ends 433 of the respective slide grooves 431, the display unit 1 is turned to a substantially horizontal position, i.e., a position substantially parallel to a plane (B) of the base 2. Therefore, the display device according to the present invention not only is adjustable in inclination angle but also is turnable to a substantially horizontal position.

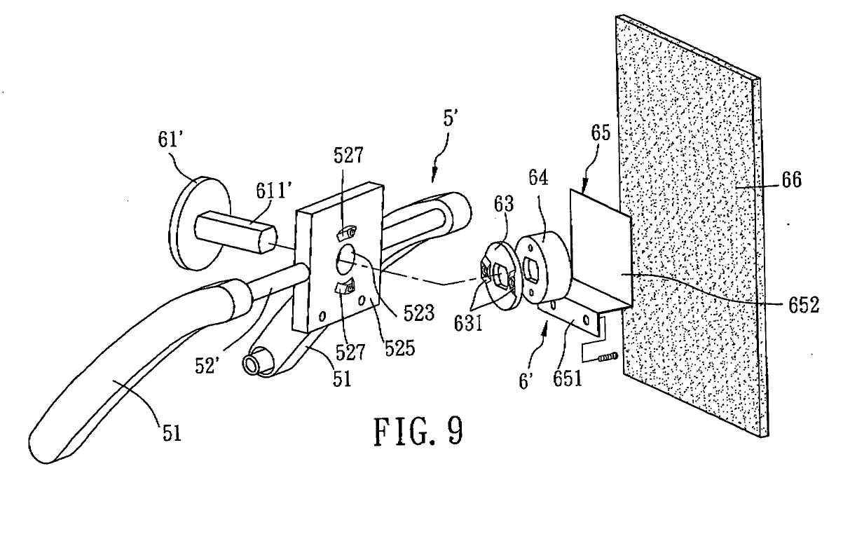

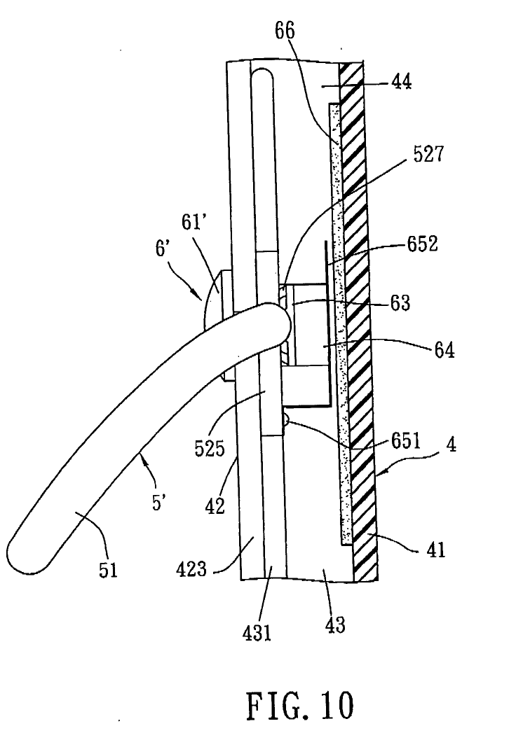

Referring to FIGS. 9 and 10, there is shown the second preferred embodiment of the display device according to the present invention. Like the first preferred embodiment, the second preferred embodiment includes a display unit 1 (not shown), a base 2 (not shown), a link unit 3 (not shown), and a slide mechanism 4 which has front and rear walls 41, 42, and side walls 43 that define a sliding space 44. The rear wall 42 has a through hole 423, whereas the side walls 43 have slide grooves 431. The second preferred embodiment differs from the first preferred embodiment in that the second embodiment includes an arm unit 5 and a locking mechanism 6′.

The arm unit 5′ includes a bridge member 52′ which interconnects two arms 51 and which has an engaging board 525 facing the front wall 41 of the slide mechanism 4. The engaging board 525 has an opening 523 and two first engagement protrusions 527 disposed above and below the opening 523, respectively. The locking mechanism 6′ includes a rotary knob 61′ with a stem 611′ extending through the opening 523, a pusher 63 connected to the stem 611′, a standoff block 64, and a second engaging member 65. A first engaging member 66 in the form of a friction plate is fixed to the front wall 41. The stem 611′ has a non-circular cross-section and extends into the pusher 62 and the standoff block 64. Two second engagement protrusions 631 are formed on the pusher 63 at two diametrically opposite positions and project towards the first engagement protrusions 527. The second engaging member 65 has a fixing part 651 fixed to the engaging board 525 of the bridge member 52′, and an abutment part 652 extending between the standoff block 64 and the first engaging member 66.

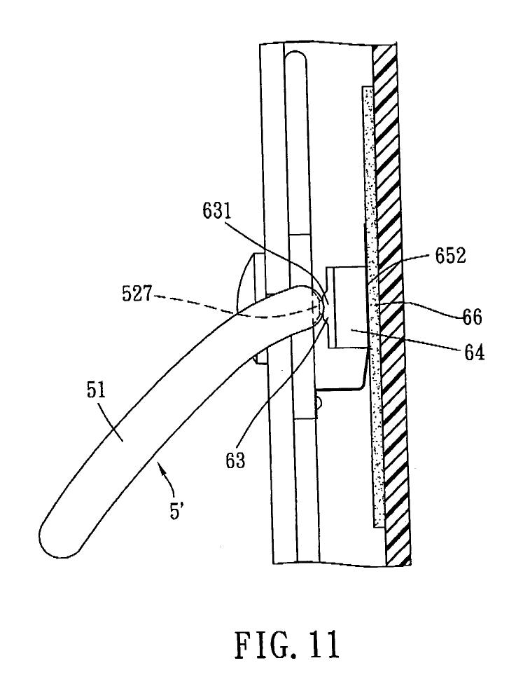

When the locking mechanism 6′ is in an unlocking position, the second engagement protrusions 631 of the pusher 63 are not aligned with the first engagement protrusions 527 of the engaging board 521. In this state, the abutment part 652 of the second engaging member 65 is spaced apart from the first engaging member 66, as shown in FIG. 10. When the pusher 63 is rotated to turn the second engagement protrusions 631 toward the respective first engagement protrusions 527, the first engagement protrusions 527 push respectively the second engagement protrusions 631 so that the pusher 63 pushes the abutment part 652 of the second engaging member 65 in an axial direction through the standoff block 64 toward the first engaging member 66, as shown in FIG. 11, thereby preventing the bridge member 52′ or the arm unit 5′ from moving relative to the display unit 1.

While the second embodiment is provided with the standoff block 64 and the first engaging member 66, alteration may be made in the second embodiment by omitting the standoff block 64 and the first engaging member 66. In this case the front wall 41 may be used as the first engaging member.

Unlike the prior art disclosed in U.S. Pat. No. 6,776,994, the display unit 1 according to the present invention is not only able to incline both forward and rearward, it is also adjustable for a wider range of inclination angles. Since the display unit 1 can be placed in a horizontal position, the display device may be installed below a table to be used by a chess player in a chess game, or on a wall of a restaurant or dining room to display information such as a menu. If the display unit 1 is an LCD display unit, the horizontal design according to the present invention will provide an increased viewing angle of up to 160 degrees. The display device according to the present invention has a novel construction which can accommodate to different places of installation and which can increase the range of viewing angles for LCD display devices.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A display device comprising:
a display unit having a display screen and a back panel;
a base;
a support mounted on said base and connected to said display unit, said support including a link unit fixed to said base and connected pivotally to a lower portion of said display unit; and
an arm unit mounted pivotally on said base and connected movably to an upper portion of said display unit, said arm unit being rotatable and slidable relative to said display unit.

2. The display device as claimed in claim 1, further comprising a slide mechanism mounted on said display unit and connected to said arm unit, said slide mechanism including a slide rail which is disposed on said back panel, said arm unit having an upper part sliding along said slide rail.

3. The display device as claimed in claim 2, wherein said slide rail extends in a top-to-bottom direction of said back panel and is substantially parallel to a plane of said display screen.

4. The display device as claimed in claim 3, further comprising a locking mechanism connected to said slide mechanism and said arm unit to lock said arm unit against movements relative to said display unit.

5. The display device as claimed in claim 4, wherein said arm unit includes a pair of arms each having an upper end, and a bridge member interconnecting said upper ends of said arms.

6. The display device as claimed in claim 5, wherein said slide mechanism includes a flat case attached to said back panel, said flat case defining said slide rail, said bridge member extending into said flat case to slide along said slide rail.

7. The display device as claimed in claim 6, wherein said locking mechanism includes a first engaging member disposed on said flat case, and a second engaging member connected to said bridge member and being engageable releaseably with said first engaging member.

8. The display device as claimed in claim 7, wherein said flat case includes a front wall fixed to said back panel, a rear wall opposite to said front wall, and left and right side walls interconnecting said front and rear walls, said front and rear walls confining a sliding space therebetween, said left and right side walls having slide grooves that extend in a top-to-bottom direction, said sliding space and said slide grooves cooperatively defining said slide rail, said bridge member being received in said sliding space and having two opposite ends that extend respectively through said slide grooves and that are connected respectively to said arms.

9. The display device as claimed in claim 8, wherein said locking mechanism further includes a pusher disposed within said flat case, and a rotary knob connected to said pusher, said rotary knob being operable to actuate said pusher, said pusher moving said second engaging member toward or away from said first engaging member when being actuated.

10. The display device as claimed in claim 9, wherein said rear wall has a through hole, said rotary knob having a stem extending through said through hole and said bridge member to connect with said pusher.

11. The display device as claimed in claim 9, wherein said first engagement member is disposed on said front wall adjacent to said pusher, said second engagement member being provided on said bridge member adjacent to said pusher.

12. The display device as claimed in claim 11, wherein said pusher moves said second engagement member in a radial direction of said rotary knob toward said first engagement member.

13. The display device as claimed in claim 11, wherein said pusher moves said second engagement member in an axial direction of said rotary knob toward said first engagement member.
